(19) United States
(12) Patent Application Publication
(10) Pub. No.: US 2019/0178098 A1
(43) Pub. Date: Jun. 13, 2019

(54) COMPRESSOR MODULE FOR A TURBOMACHINE

(71) Applicant: MTU Aero Engines AG, Munchen (DE)

(72) Inventor: Roland Wunderer, Haimhausen (DE)

(73) Assignee: MTU Aero Engines AG, Munchen (DE)

(21) Appl. No.: 16/210,786

(22) Filed: Dec. 5, 2018

(30) Foreign Application Priority Data
Dec. 7, 2017 (DE) 10 2017 222 210.7

(51) Int. Cl. F01D 9/06; F01D 25/30; F02K 3/06; F01D 9/04

(52) U.S. Cl. CPC F01D 9/06; F01D 25/30; F04D 29/544; F01D 9/041; F02K 3/06

(57) ABSTRACT

The invention relates to a compressor module that forms a compressor gas duct for guiding a compressor gas that is to be compressed, wherein a flow bypass structure extends radially through the compressor gas duct between an inner housing wall and an outer housing wall, and wherein, in a wall surface of the inner housing, with which the inner housing wall bounds the compressor gas duct radially inward, an exhaust orifice for partial exhaust of the compressor gas guided in the compressor gas duct is arranged, wherein, for guiding the exhaust gas that is discharged through the exhaust orifice, an exhaust duct adjoins the exhaust orifice, and wherein the exhaust duct extends through the flow bypass structure radially outside of the compressor gas duct.

### TECHNICAL FIELD

The present invention relates to a compressor module for a turbomachine.

### PRIOR ART

The turbomachine can be, for example, a jet engine, such as, for example, a turbofan. Functionally, the turbomachine is divided into a compressor, a combustion chamber, and a turbine. For instance, in the case of the jet engine, intake air is compressed by the compressor and combusted with admixed fuel in the downstream combustion chamber. The resulting hot gas, a mixture of combustion gas and air, flows through the downstream turbine and is thereby expanded. In this case, the turbine also takes energy in part from the hot gas in order to drive the compressor.

The present subject is directed at the compressor or a module thereof; however, the subject is explicitly not to be limited initially to the jet engine taken into account for illustration; an application in a stationary gas turbine is also possible, for example.

### DESCRIPTION OF THE INVENTION

The present invention is based on the technical problem of specifying an especially advantageous compressor module for a turbomachine.

In accordance with the invention, this problem is solved by a compressor module according to claim 1. This compressor module forms a compressor gas duct for guiding the gas to be compressed (in the following, also “compressor gas”) and, in the compressor gas duct, has a flow bypass structure, which extends radially between an inner housing wall and an outer housing wall of the compressor module. In this case, arranged in a wall surface of the inner housing, with which the inner housing wall bounds the compressor gas duct radially inward, is an exhaust orifice for the partial exhaust of the compressor gas into an exhaust duct. In accordance with the invention, this exhaust duct extends radially outward through the flow bypass structure, and hence the discharged gas (in the following, also “exhaust gas”) is therefore guided radially outside of the compressor gas duct. On the one hand, the exhaust at the inner housing wall can be of advantage in terms of fluid dynamics (see below in detail). On the other hand, the guidance of the exhaust gas radially outward can be of advantage in this regard, for example, in that more structural space is available there.

Preferred embodiments are found in the dependent claims and in the entire description, whereby, in the presentation of the features, a distinction is not always made in detail between device aspects and method aspects or use aspects; in any case, the disclosure is to be read implicitly in regard to all claim categories. Unless explicitly stated otherwise, the specific details always refer to both the compressor module and to a compressor equipped with said compressor module or a corresponding turbomachine.

The compressor gas is the gas that flows through a compressor arrangement upstream of the combustion chamber and is thereby compressed; in the case the jet engine, therefore, this gas is the intake air. For purposes of terminological distinction, that part of the gas that exits the compressor gas duct through the exhaust orifice in the wall surface of the inner housing is referred to as “exhaust gas.” On account of the overpressure in the compressor gas duct, the compressor gas exits to a (very small) extent through the exhaust orifice and is therefore, so to speak, blown out. The compressor module forms the compressor gas duct, in which the compressor gas is guided in the direction of the combustion chamber inlet. The compressor gas duct is bounded radially inward by the wall surface of the inner housing and radially outward by an outer housing wall surface of the outer housing wall. The wall surface of the inner housing and the wall surface of the outer housing lie radially opposite to each other; the former faces radially outward, the latter radially inward.

In general, in the scope of this disclosure, “axial” relates to the longitudinal axis of the compressor module and thus consequently to the longitudinal axis of the compressor or of the turbomachine. This longitudinal axis can coincide with an axis of rotation, for example, around which the rotating blades of a compressor stage or of a compressor rotate. “Radial” refers to the radial directions that are perpendicular to the longitudinal axis and are directed away from it, and a “periphery” or the “peripheral direction” or “peripherally” refers to the rotation around the longitudinal axis. Furthermore, in the scope of this disclosure, “a” and “one” are indefinite articles, unless explicitly stated otherwise, and thus are always to be also read as “at least one.” There can be, for example, a plurality of flow bypass structures distributed peripherally or else a plurality of exhaust orifices, etc.; see below in detail.

The exhaust gas is brought through the flow bypass structure radially outside of the compressor gas duct; there, in contrast to radially inward, it is easier in terms of design for further guidance to occur, for example. The structural space radially within is limited, and, in addition, the shaft or shafts with the associated bearings, etc. is or are arranged there. Radially outside of the compressor gas duct, the exhaust gas can then be guided, for example, to the combustion chamber or to the turbine and utilized as a cooling fluid. However, exhaust gas that is guided radially outward can also open up more extensive application possibilities, and, for instance, in the case of an aircraft engine, can also be utilized by the aircraft itself, for example, for supplying pressure to the cabin or, in general, for pneumatic systems (air-conditioning units, etc.).

The exhaust of the exhaust gas at the wall surface of the inner housing can be advantageous in terms of fluid dynamics, for example, because, as a result, it is possible to dissipate thick and thus strongly loaded boundary layers of the flow. In consequence thereof, compressor gas can be displaced from a core region of the flow, where the compressor gas has a higher kinetic energy, toward the wall surface of the inner housing, thereby resulting in a newly formed boundary layer of higher energy downstream of the exhaust orifice. Said boundary layer is then less subject to loss, for example, and hence is less at risk of separation. Such an advantage in terms of fluid dynamics can result, in particular, in a curvature, but can also be advantageous upstream of a curvature (namely, it can help to prevent an accumulation of loaded boundary layers).

In a preferred embodiment, the wall surface of the inner housing extends axially with a sectional curvature. Thus, this curvature exists in relation to sectional planes, each of which includes the longitudinal axis (see above). From the point of view of the flowing compressor gas, the curvature causes a change in direction or an offset, which loads the boundary surfaces or interfaces in terms of fluid dynamics. Preferably, the curvature does not extend axially over the entire wall surface of the inner housing, but rather only over a part thereof, at which upstream and/or downstream sections adjoin, and, as viewed in themselves in said sectional planes, are straight. Unless explicitly stated otherwise, upstream/downstream refer to the compressor gas in the compressor gas duct.

The exhaust orifice is preferably arranged upstream in the curvature and/or of the curvature. In this regard, the latter can be advantageous, for example, in that, before the curvature that is actually critical in terms of fluid dynamics, a previously built-up loaded boundary layer can then be at least partially dissipated. Also explicitly possible is a combination, and, therefore, the exhaust orifice can be placed in part upstream of the curvature and extend into it.

In a preferred embodiment, the wall surface of the inner housing extends convexly in the region of the curvature, which, in turn, refers to the sectional planes that include the longitudinal axis. The exhaust orifice can be used to prevent any disruption of the flow.

In a preferred embodiment, the flow bypass structure is formed as a blade, and therefore, in relation to the bypass flow of the compressor gas, has a leading edge upstream and a trailing edge downstream. Extending between the leading edge and the trailing edge are two lateral surfaces that lie opposite to each other; the blade can be profiled or else not profiled in design. Preferably, one lateral surface is designed as a suction-side surface and the other is designed as a pressure-side surface.

In a preferred embodiment, the flow bypass structure formed as a blade is designed to be at most weakly deflecting in relation to the bypass flow of the compressor gas. This means a deflection of no more than 5°, 4°, or 3° (increasingly preferred in the order given). The blade can also be provided so as not to be deflecting) (0°); however, on the other hand, there can also be a lower limit at, for example, at least 1°.

In a preferred embodiment, the flow bypass structure either itself forms a bearing support strut or it represents a fairing of such a bearing support strut. Preferred is a combination with the embodiment as a blade, which is then also referred to as a support blade or strut. A “support strut” is a bearing component of the compressor module, which bears an inner housing region arranged radially inside of the compressor gas duct and an outer housing region arranged radially outside of it. Preferably, the support strut can carry a bearing of the compressor shaft, at least indirectly. Preferably, it is then possible to provide a plurality of support struts peripherally in a spoke-like arrangement; the support struts can then jointly hold the bearing in a centered manner in the housing. On the one hand, the flow bypass structure itself can represent the support strut; however, on the other hand, the flow bypass structure can also be combined with the support strut as a fairing, that is, as a cladding of the actually bearing support strut, for optimization in terms of fluid dynamics.

In a preferred embodiment, the flow bypass structure itself, that is, in any case, that section thereof that extends radially through the flow bypass structure bounds the exhaust duct. The flow bypass structure material, which is used to provide the flow bypass structure, therefore, on the one hand, bounds the exhaust duct inward and, on the other hand, forms an outer surface of the flow bypass structure that faces the compressor gas (which, however, for example, can also be furnished with a protective layer). In general, in contrast, the flow bypass structure could also represent solely a fairing/cladding, in which a fluid line forming the exhaust duct or a mechanical shaft guided outward is then placed. In the case of the preferred integral embodiment, the exhaust duct can be taken into consideration already in the casting mold during production by mold casting. However, this is not compulsory; for example, the flow bypass structure can also be built up by additive manufacture (from a data model by layer-by-layer selective solidification of a material), whereby it is also possible to take into consideration an integral exhaust duct.

In a preferred embodiment, at least one section of the exhaust orifice of the flow bypass structure is placed upstream (in relation to the compressor gas flow). It is also possible for the entire exhaust orifice of the flow bypass structure to extend upstream, that is, for example, to lie upstream of the leading edge of a previously described blade. On the other hand, however, the exhaust orifice can also extend in part downstream beyond the leading edge of the flow bypass structure.

In a preferred embodiment, a plurality of flow bypass structures are provided peripherally. “Plurality” generally means at least 2, with it being further possible increasingly to prefer at least 3, 4, 5, 6, 7, 8, 9, or 10 in the order given. Upper limits, which are independent of the lower limits, can lie at, for example, at most 100, 80, 60, 40, 30, 20, or 15. Preferably, the peripherally provided flow bypass structures are rotationally symmetric with respect to one another.

In a preferred embodiment, in relation to the peripheral direction, at least one section of the exhaust orifice extends between two mutually peripherally nearest-neighbor flow bypass structures. In this case, the exhaust orifice can actually extend continuously from the one flow bypass structure to the nearest-neighbor flow bypass structure; that is, it can have an oblong shape in the peripheral direction. On the other hand, the exhaust orifice can also have, for example, a round shape, such as, for instance, an elliptical shape or, in particular, a circular shape. In particular, such an exhaust orifice can then also fill the path between the flow bypass structures only in part, with it then being possible to provide between the flow bypass structures preferably also (a) further exhaust orifice(s).

On the one hand, the entire exhaust orifice can be arranged between the flow bypass structures; on the other hand, however, it can also extend in part upstream of the flow bypass structures; see above. In general, the just depicted shaping (“oblong in the peripheral direction” or “round”) may also be of interest in the case of an exhaust orifice that is overall upstream of the flow bypass structure.

In a preferred embodiment, a plurality of exhaust orifices are provided in the wall surface of the inner housing and are jointly associated with the exhaust duct guided radially outward through the flow bypass structure. Reference is made to the previous statements in regard to “plurality.” In the wall surface of the inner housing, however, there overall can be even substantially more exhaust orifices, which, in each case, are then associated groupwise with a respective flow bypass structure (with the exhaust duct therein). The exhaust gas exiting through the individual exhaust orifices associated jointly with the flow bypass structure can be combined, for example, at a collection point in the inner housing. From there, the exhaust gas then enters the flow bypass structure radially outward through the exhaust duct. A collection point in the inner housing may also be preferred in general, for example, in order to expand the exhaust gas after its exit through the exhaust orifice and before it is guided through the flow bypass structure.

In a preferred embodiment, the compressor module, together with the exhaust gas guidance according to the invention, is a compressor mid frame. Said compressor mid frame can be or is arranged, for example, between an (axially last) compressor and the combustion chamber; preferred is an arrangement between two compressors. A “compressor” is composed, as a rule, of a plurality of stages; typically, each stage has a ring of rotating blades and a successively following ring of guide vanes. For example, the rotating blade rings of one compressor can rotate on the same shaft and the rotating blade rings of another compressor can rotate on another shaft. In general, the “compressor module” described in the context of this disclosure can also be a compressor; the exhaust duct can then be guided radially outward through a guide vane of the compressor. Preferably, the compressor module is a compressor mid frame.

The compressors can differ from one another in terms of their radial position, because, for example, they are operated with different rotational speeds. This can result in a radial offset between the compressors, which, in the interposed compressor mid frame, causes a curved course of the compressor gas duct. This can result, in particular, in a previously described, curved course of the wall surface of the inner housing. Especially in the convexly curved regions, the flow is then strongly loaded and, through the arrangement of the exhaust orifice(s) there, it is possible to reduce the risk of a separation (newly formed boundary layer or interface with higher energy; see above). Although the problem of the strongly loaded interfaces also could be addressed, if need be, with a compressor gas duct of sufficient axial longitudinal extent, the structural length of the turbomachine is thereby increased overall. This can already be a drawback because of the greater material requirement; in the case of an aircraft engine, the higher weight then ultimately also means an increased fuel consumption.

The invention also relates to a compressor arrangement, which comprises a compressor module according to the invention that is formed as a compressor mid frame and at least one compressor; see also the previous comments. Preferably, the compressor arrangement has at least two compressors, between which the compressor mid frame is arranged. As a rule, the compressor arrangement will have no more than four or three compressors. Preferably, a respective compressor mid frame designed in accordance with the invention can be arranged between all of the compressors.

The invention also relates to the use of a presently disclosed compressor module or of a compressor arrangement in a turbomachine and, in general, for example, also in a gas turbine. Preferably, the use is in an aircraft engine, in particular, a jet engine.

### BRIEF DESCRIPTION OF THE FIGURES

The invention will be described below in detail on the basis of an exemplary embodiment, whereby the individual features in the scope of the independent claims can also be essential to the invention in other combinations and also a distinction between the different claim categories is not made individually.

Individually:

FIG. 1 shows a jet engine in a longitudinal section;

FIG. 2 shows a compressor mid frame as part of a compressor arrangement of the jet engine in accordance with FIG. 1;

FIG. 3 shows a flow bypass structure of the compressor mid frame in accordance with FIG. 2 cut in a section;

FIGS. 4a-d show two flow bypass structures, respectively, in accordance with FIG. 3, having differently arranged exhaust orifices.

### PREFERRED EMBODIMENT OF THE INVENTION

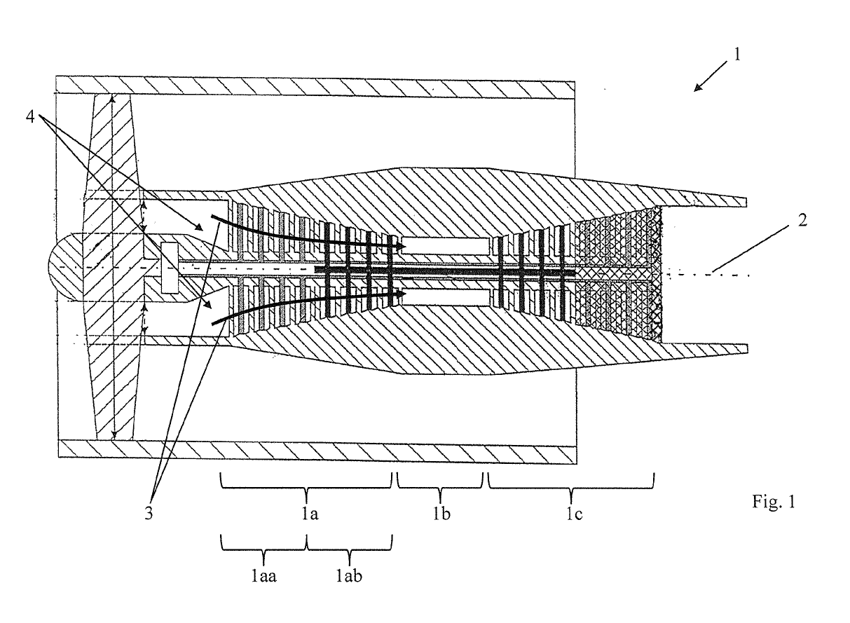

FIG. 1 shows a turbomachine 1 cut in section, concretely a jet engine (turbofan). The turbomachine 1 is divided functionally into the compressor arrangement 1a, the combustion chamber 1b, and the turbine 1c. Both the compressor arrangement 1a and the turbine 1c are each composed of a plurality of modules, the compressor arrangement 1a in the present case being composed of a low-pressure compressor 1aa and a high-pressure compressor 1ab. Each compressor 1aa, 1ab, on its part, is composed of a plurality of stages; as a rule, each stage is composed of a ring of rotating blades and a successively following ring of guide vanes. In operation, the compressor gas 3—in the present case, air—flows through the compressor arrangement 1a axially in relation to a longitudinal axis 2 and, namely, flows in a compressor gas duct 4. The compressor gas 3 is thereby compressed; in the combustion chamber 1b, fuel is then admixed and this mixture is combusted.

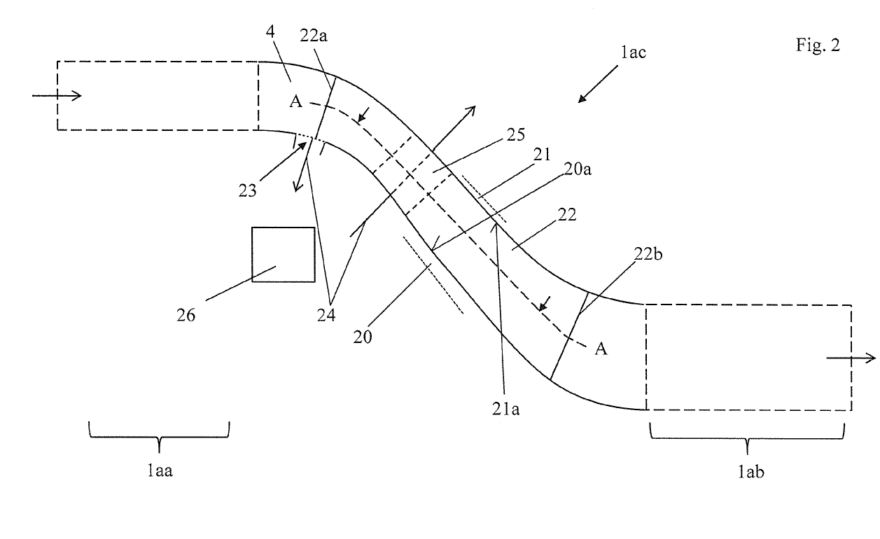

FIG. 2 illustrates a part of the compressor arrangement 1a that is not illustrated individually in FIG. 1, namely, a compressor mid frame 1ac. Shown is, in turn, a longitudinal section (the longitudinal axis 2 lies in the sectional plane). The compressor mid frame 1ac joins the low-pressure compressor 1aa to the high-pressure compressor 1ab. Because the compressors 1aa, 1ab rotate at different rotational speeds (see FIG. 1; they run on different shafts), they are radially different in dimension. In the region of the low-pressure compressor 1aa, the compressor gas duct 4 lies radially further outward than in the region of the high-pressure compressor 1ab. In accordance therewith, the compressor gas duct 4 extends in a curved manner in the region of the compressor mid frame 1ac.

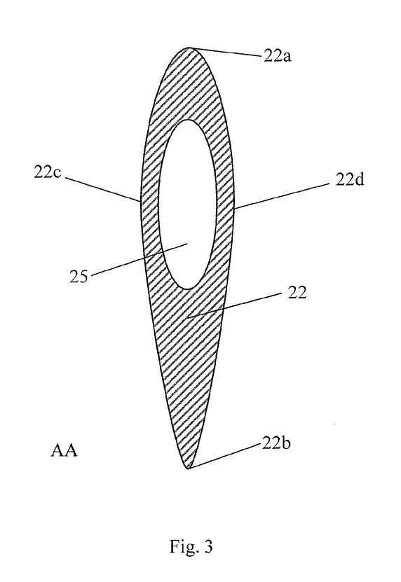

As can be seen from FIG. 2, the compressor gas duct 4 is framed radially between an inner housing wall 20 and an outer housing wall 21. An inner housing wall surface 20a of the inner housing wall 20 bounds the compressor gas duct 4 radially inward and the outer housing wall surface 21a of the outer housing wall 21 bounds it radially outward. Furthermore, a flow bypass structure 22 is arranged in the compressor gas duct 4; compare for illustration also the section in accordance with FIG. 3. The flow bypass structure 22 is formed as a blade and has a leading edge 22a as well as a trailing edge 22b. Furthermore, in the present case, it serves a support function; it thus represents a bearing connection between radially inward-lying and radially outward-lying parts of the compressor mid frame 1ac.

On account of the curved extension of the compressor gas duct 4, the wall surface of the inner housing 20a is also curved in sections, namely, convexly in a first section and concavely in a second section. In particular, the convex curvature leads to a strongly loaded flow at the interface. Arranged in the present case, therefore, in the curvature in the convex portion is an exhaust orifice 23, through which a relatively small part of the compressor gas 3 is expelled as an exhaust gas 24. This exhaust gas 24 is collected at a collection point 26 and brought through an exhaust duct 25, which extends through the flow bypass structure 22, radially outside of the compressor gas duct 4. There, more structural space is available or more extensive application possibilities result; see the introduction to the description.

FIG. 3 shows the flow bypass structure 22 cut in a section; see the sectioning line AA in accordance with FIG. 2. In this cut section, in addition to the leading edge 22a and the trailing edge 22b, the lateral surfaces 22c,d can also be seen. It is further possible to see the arrangement of the exhaust duct 25, through which the exhaust gas 24 flows perpendicularly or at an angle to the plane of the drawing. The exhaust duct 25 can be taken into consideration during manufacture in a mold casting method, for example, by way of a casting core; however, the flow bypass structure 22 can also be built up, for example, by additive manufacture (whereby the exhaust duct 25 remains open).

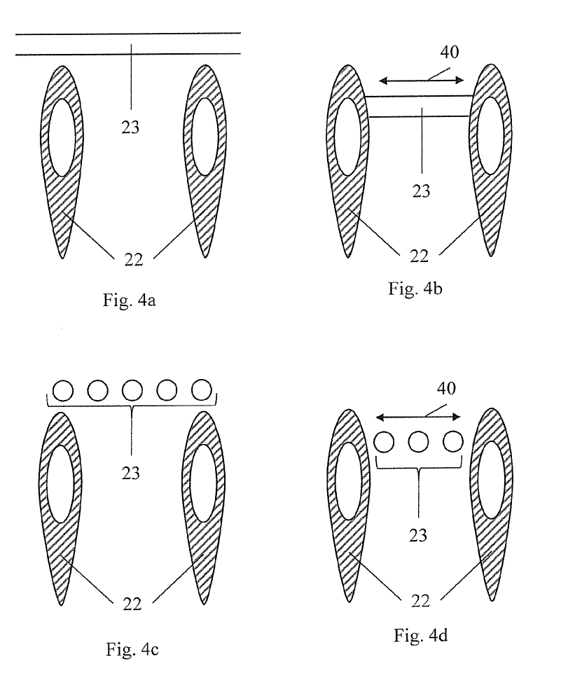

FIGS. 4ac each show two such flow bypass structures 22, which follow each other successively in the peripheral direction 40. It is possible to provide approximately 10 flow bypass structures 22 over the entire periphery, for example; compare also the introduction to the description.

In the variant in accordance with FIG. 4a, the exhaust orifice 23 extends longitudinally in the peripheral direction 40 and, in relation to the compressor gas flow, it is arranged upstream of the flow bypass structures 22. The variant in accordance with FIG. 4b also shows a longitudinally extending exhaust orifice 23, which, in this case, however, in relation to the peripheral direction 40, extends between the flow bypass structures 22.

The variants in accordance with FIGS. 4c,d each show a plurality of exhaust orifices 23. They can be combined groupwise, whereby the respective discharged exhaust gas 24 is then combined at the collection point 26 and brought radially outside through a common exhaust duct 25 (see also FIG. 2 with respect to the collection point 26). This notwithstanding, the exhaust orifices 23 can be arranged upstream of the flow bypass structures 22 in analogy to FIGS. 4a,b or else they can be arranged in the peripheral direction 40 in between.

### LIST OF REFERENCE CHARACTERS

Turbomachine 1

Compressor arrangement 1a

Low-pressure compressor 1aa

High-pressure compressor 1ab

Compressor mid frame 1ac

Combustion chamber 1b

Turbine 1c

Longitudinal axis (of the turbomachine) 2

Compressor gas 3

Compressor gas duct 4

Inner housing wall 20

Wall surface of the inner housing 20a

Outer housing wall 21

Wall surface of the outer housing 21a

Flow bypass structure 22

Leading edge thereof 22a

Trailing edge thereof 22b

Lateral surfaces 22c,d

Exhaust orifice 23

Exhaust gas 24

Exhaust duct 25

Collection point 26

Peripheral direction 40

1. A compressor module for a turbomachine, the compressor module forming including a compressor gas duct for guiding a compressor gas that is to be compressed,
wherein a flow bypass structure extends radially through the compressor gas duct between an inner housing wall and an outer housing wall, and
wherein, in a wall surface of the inner housing, with which the inner housing wall bounds the compressor gas duct radially inward, an exhaust orifice for partial exhaust of the compressor gas guided in the compressor gas duct is arranged, wherein, for guiding the exhaust gas that is discharged through the exhaust orifice, an exhaust duct adjoins the exhaust orifice, and
wherein the exhaust duct extends through the flow bypass structure radially outside of the compressor gas duct.

2. The compressor module according to claim 1, wherein the wall surface of the inner housing extends axially with a curvature, and the exhaust orifice is arranged upstream in the curvature and/or of the curvature in relation to the compressor gas guided in the compressor gas duct.

3. The compressor module according to claim 2, wherein the wall surface of the inner housing is convexly curved in the curvature.

4. The compressor module according to claim 1, wherein the flow bypass structure is configured as a blade, which, in relation to the bypass flow of the compressor gas guided in the compressor gas duct, has a leading edge and a trailing edge as well as two lateral surfaces, each extending between the leading edge and the trailing edge.

5. The compressor module according to claim 4, wherein the blade is shaped in a weakly deflecting manner by at most 5°.

6. The compressor module according to claim 1, wherein the flow bypass structure forms a bearing support strut or represents a fairing of such a strut.

7. The compressor module according to claim 1, wherein, in its interior, the flow bypass structure itself in its interior bounds at least one section of the exhaust duct.

8. The compressor module according to claim 1, wherein, in relation to the compressor gas guided in the compressor gas duct, the exhaust orifice extends at least in part upstream of the flow bypass structure.

9. The compressor module according to claim 1, wherein a plurality of flow bypass structures are provided in the compressor gas duct in a distributed manner in the peripheral direction.

10. The compressor module according to claim 9, wherein, in relation to the peripheral direction, the exhaust orifices are arranged at least in part between two mutually nearest neighbors of the flow bypass structures.

11. The compressor module according to claim 1, wherein, in the wall surface of the inner housing, a plurality of exhaust orifices are provided, which are jointly associated with the exhaust duct extending radially outside through the flow bypass structure.

12. The compressor module according to claim 1, wherein the compressor module is formed as a compressor mid frame.

13. The compressor module according to claim 12 wherein a compressor is arranged upstream of the compressor mid frame.

14. The compressor module according to claim 13 further comprising another compressor that is arranged downstream of the compressor module formed as a compressor mid frame.

15. The compressor module is configured and arranged for use in a turbomachine.
